(19) United States
(12) Patent Application Publication
(10) Pub. No.: US 2019/0069492 A1
(43) Pub. Date: Mar. 7, 2019

(54) MACHINE FOR FORMING AND WRAPPING SQUARE BALES

(71) Applicants: James Mathes, Chariton, IA (US); Justin Mathes, Chariton, IA (US); Andrew Turner, Chariton, IA (US)

(72) Inventors: James Mathes, Chariton, IA (US); Justin Mathes, Chariton, IA (US); Andrew Turner, Chariton, IA (US)

(21) Appl. No.: 16/118,819

(22) Filed: Aug. 31, 2018

Related U.S. Application Data
(60) Provisional application No. 62/554,244, filed on Sep. 5, 2017.

(51) Int. Cl. A01F 15/08; A01F 15/04

(52) U.S. Cl. CPC A01F 15/08; A01F 15/042

(57) ABSTRACT

A combination baling and wrapping machine is provided to enclose harvested material in a protective layer to eliminate or minimize spoilage. The machine includes a bale forming station or compartment with vertical and horizontal compactors to form the bales, and a downstream wrapping station with a first zone for wrapping the bale in a first direction and a second zone for wrapping the bale in a transverse direction, such that the bale is completely enclosed by the wrap material. The machine can be operated while moving through a field or while sitting in a stationery position.

### CROSS-REFERENCE TO RELATED APPLICATIONS

This application claims priority to Provisional Application U.S. Ser. No. 62/554,244, filed on Sep. 5, 2017, which is herein incorporated by reference in its entirety.

### FIELD OF THE INVENTION

The present invention is directed towards a machine and method for use in the agricultural industry, and in particularly, for forming and wrapping bales of harvested materials.

### BACKGROUND OF THE INVENTIONS

Harvesting of crops and crop residue has taken many forms over the years, including shocks, lose piles, square bales, small round bales, and large round bales. The harvested material may include forage, stover, silage, stalks, stubble, hay, straw, and other biomass or cellulosic materials. Storage wrapping or bagging the bales is common for outdoor storage. Despite the changes and improvements over time, problems in harvesting and storage still exists, including, but not limited to, the need to stop to dump a bale, transportation of baled or chopped materials, feeding of the materials, spoilage of the material indoors and out, as well as significant costs for equipment and labor.

In the Midwest, the spring and fall harvest seasons are relatively short, and bad weather can complicate the harvest process. The harvested materials need to be easily transportable, and need to maintain marketable quality. Also, when the material is used for animal feed, there is significant waste in providing more feed than necessary, or letting leftover material spoil. Also, in order to feed small amounts of material, the natural seal of the material must be broken, which further expedites spoilage if not fed fast enough. Also, some materials, such as hay, require expensive grinding or chopping before being dispensed for feed.

The conventional harvesting method involves multiple workers and pieces of equipment, all at significant costs. Once the material is cut, it is then baled and wrapped, bagged, or sealed. For example, typically it takes 5 people to cut or chop the material, bale the material, and wrap the material during the four-week spring and six-week Midwest fall harvesting season. Also, fully sealing a bale is difficult. Conventional bale wrappers move around the longitudinal axis of the bale, but fail to completely seal the ends of the bale, which leads to spoilage due to the exposure of the material to oxygen. Also, the material is often green or moist when baled, which makes it difficult for the plastic wrap to stick to the baled material.

Current baling methods are not continuous in the field. Conventional balers are stationery, thus require constant stop and go movement through the field.

Some balers are also prone to loss of material before or during wrapping, which leads to further waste and expense.

As an alternative to in-the-field baling, some operations pick up the cut crop or residue, and then deposit it in silage carts, and drive the carts to a remote baling operation. Such a baling process requires additional workers and carts, all of which add to the cost of the operation.

Accordingly, a primary objective of the present invention is a provision of a single machine for baling and wrapping agricultural material on the fly in the field as the material is harvested.

Another objective of the present invention is a provision of a baling and wrapping machine which completely seals the bale with little, if any loss of material.

Still another objective of the present invention is the provision of a machine for forming and wrapping square bales with a minimum amount of labor and equipment.

Another objective of the present invention is the provision of a machine for forming and wrapping square bales which are easy to handle for transport and storage.

Yet another objective of the present invention is the provision of a method for forming and wrapping square bales while the machine is moving through a field where the material is being harvested.

A further objective of the present invention is a provision of a method of forming and wrapping bales of harvested materials in a field with minimal labor and equipment.

Still another objective of the present invention is the provision of a combination baling and bale wrapping machine which can be operated while moving and while stationary.

Yet another objective of the present invention is a provision of a combination baling and wrapping machine which is easy to operate, and safe and durable in use.

These and other objectives have become apparent from the following description of the invention.

### SUMMARY OF THE INVENTION

The bale forming and wrapping machine of the present invention is mounted on a trailer or flat bed for pulling through a field for use as crop material is harvested in the field. The machine can operate on the fly while being pulled through the field, or can be set at a desired location for use while stationary.

The machine includes a bale forming station and a bale wrapping station. The forming station includes a vertical compaction plate or press and a horizontal compaction plate or press. After the harvested material is compacted, the resulting bale is ejected from the forming compartment into a first wrapping zone of the wrapping station, wherein a ring with plastic wrap rotates about a longitudinal axis so as to wrap the bale in a first direction. The partially wrapped bale then moves to the second wrapping zone of the wrapping station wherein the bale is rotated about its longitudinal axis, while a second roll of plastic wrap on a frame is rotated about a vertical axis so as to wrap the bale in a second direction, and thereby completely enclose and seal the bale. The wrapped bales can then be transported for use or storage.

### BRIEF DESCRIPTION OF THE DRAWINGS

FIGS. 1, 2, and 3 are perspective views of the baling and wrapping machine according to the present invention.

FIGS. 4 and 5 are side elevation views of the machine, from opposite sides.

FIG. 6 is a front-end elevation view of the machine.

FIG. 7 is a rear end elevation view of the machine.

FIG. 8 is a top plan view of the machine.

FIG. 9 is a sectional view along a laterally extending vertical plane through the middle of the compression chamber.

FIG. 10 is a sectional view through a vertical plane extending through the longitudinal center of the machine.

FIG. 11 is another sectional elevation view, similar to FIG. 10.

FIG. 12 is a perspective schematic, with the side walls of the compression chamber removed for clarity, with the compression components in an initial state, with the chamber empty and ready to receive harvested material.

FIG. 13 is another perspective schematic with the compression chamber walls removed for clarity and showing the chamber filled with harvested material, before any compression.

FIG. 14 is a view similar to FIG. 13 following the initial vertical compression of the material.

FIG. 15 is a view similar to FIG. 14 following the horizontal compression of the material.

FIG. 16 is a view similar to FIG. 15 showing the beginning ejection or extrusion of a square bale from the compression compartment into the first wrapping station.

FIG. 17 is another schematic view showing the bale entering the second wrapping station.

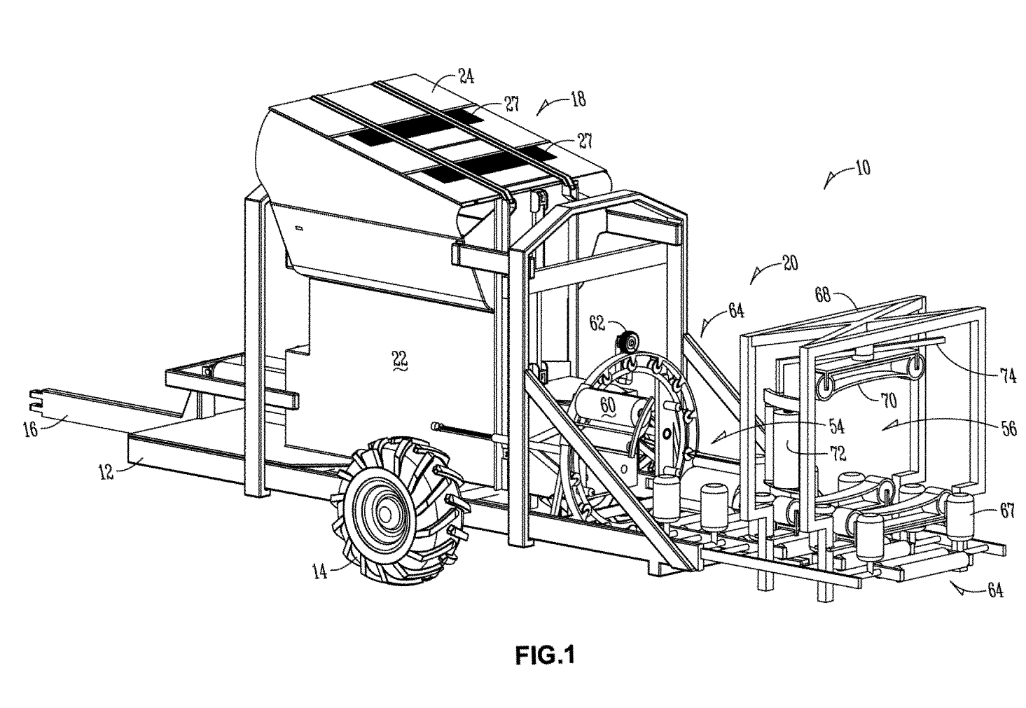

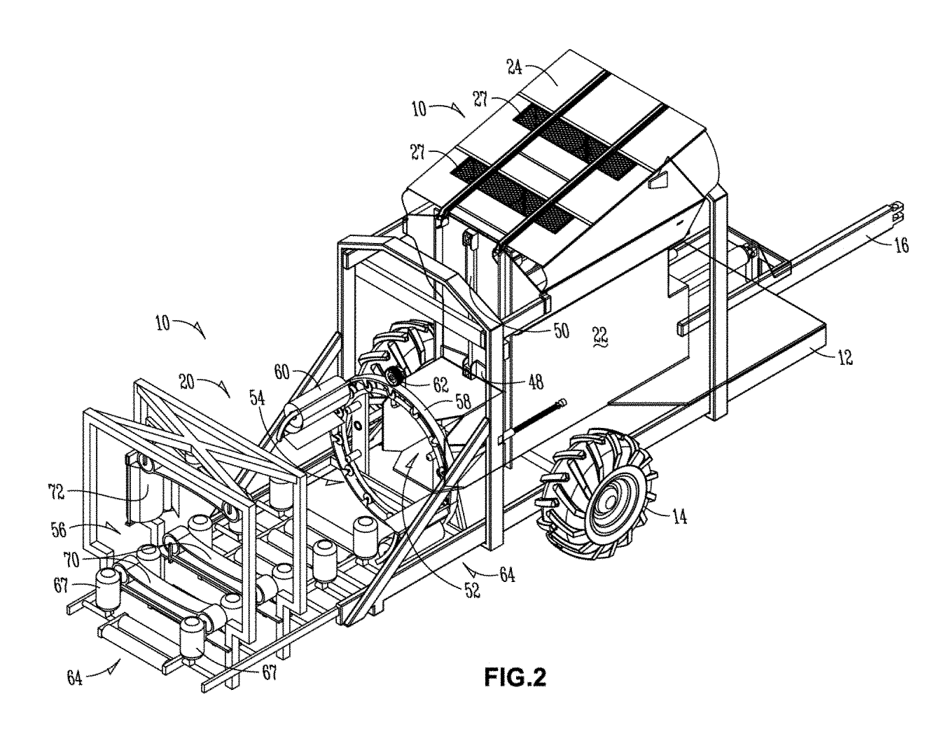

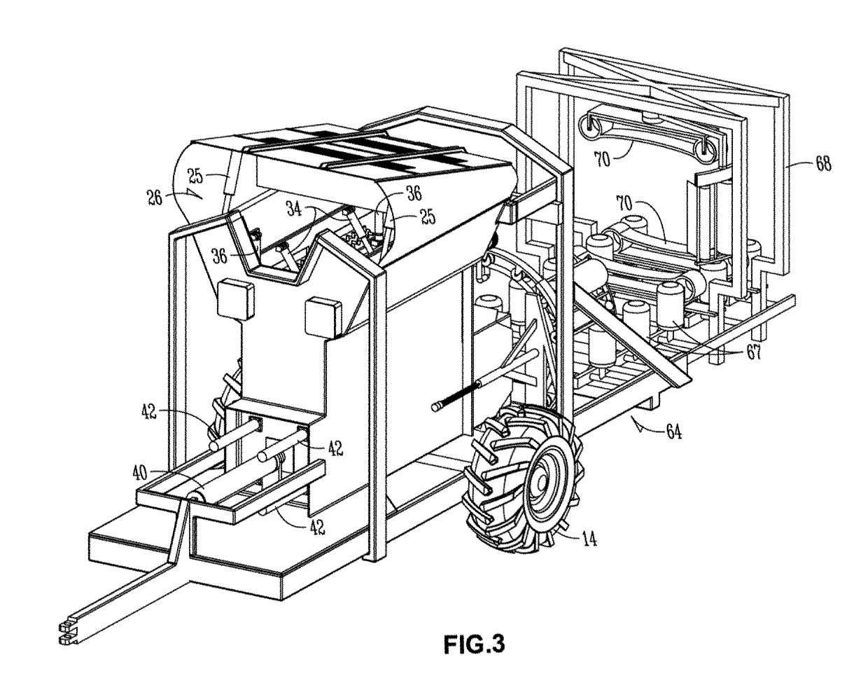

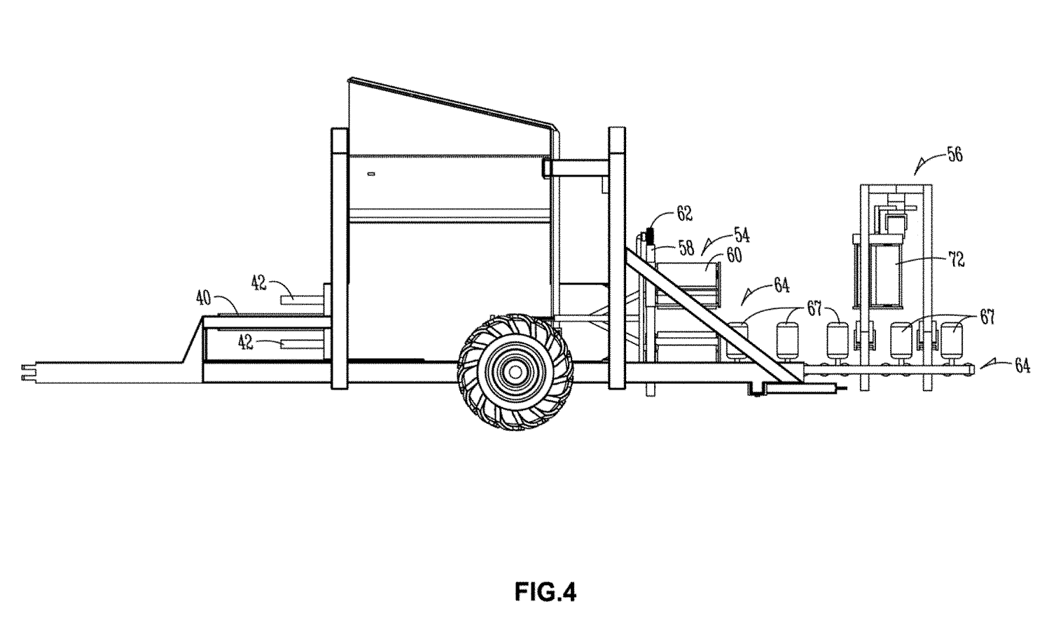

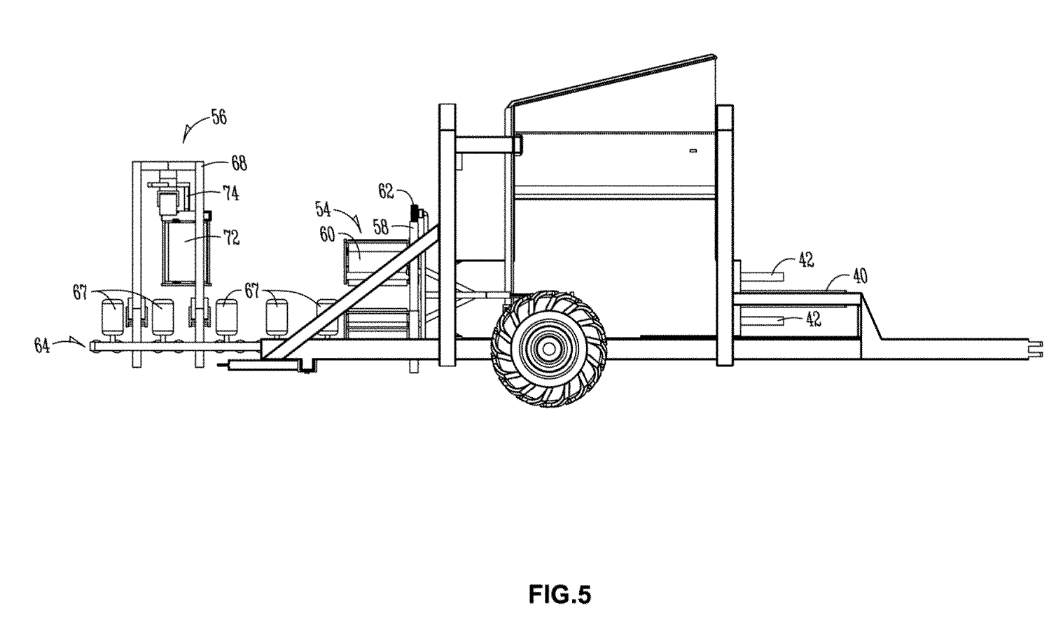

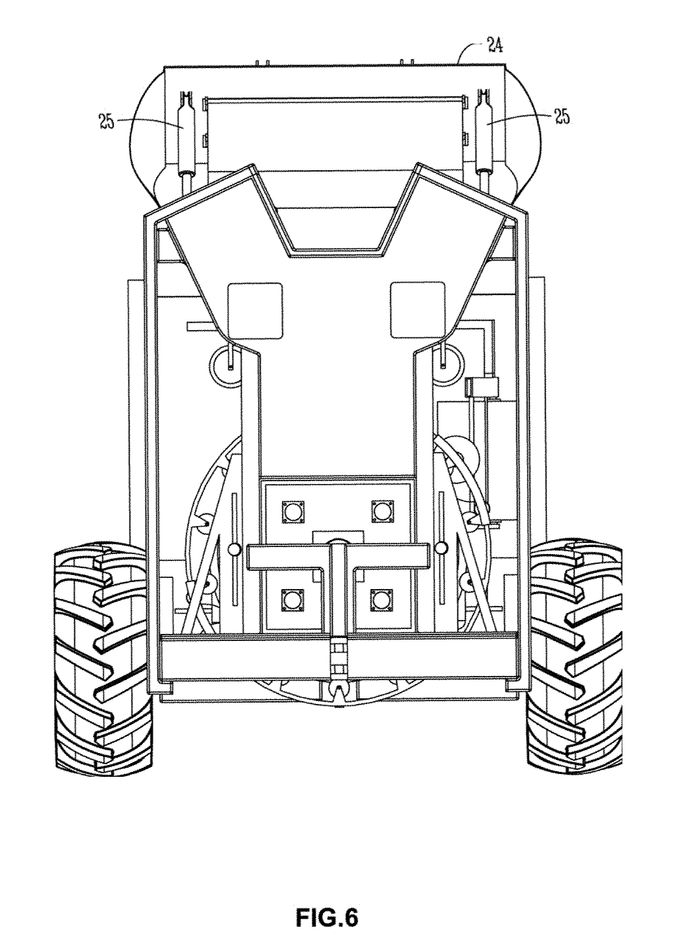

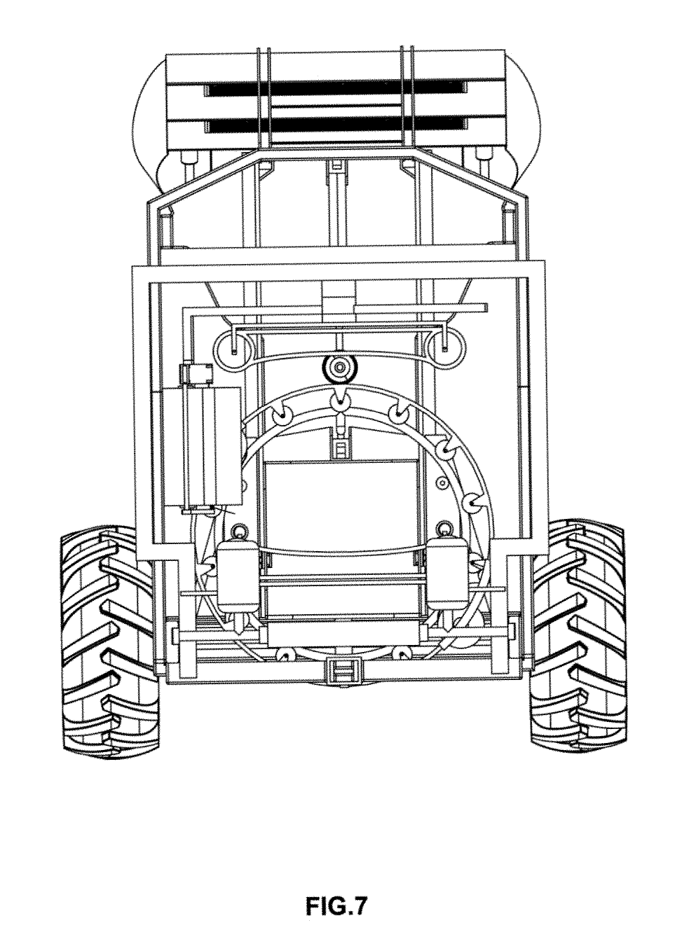

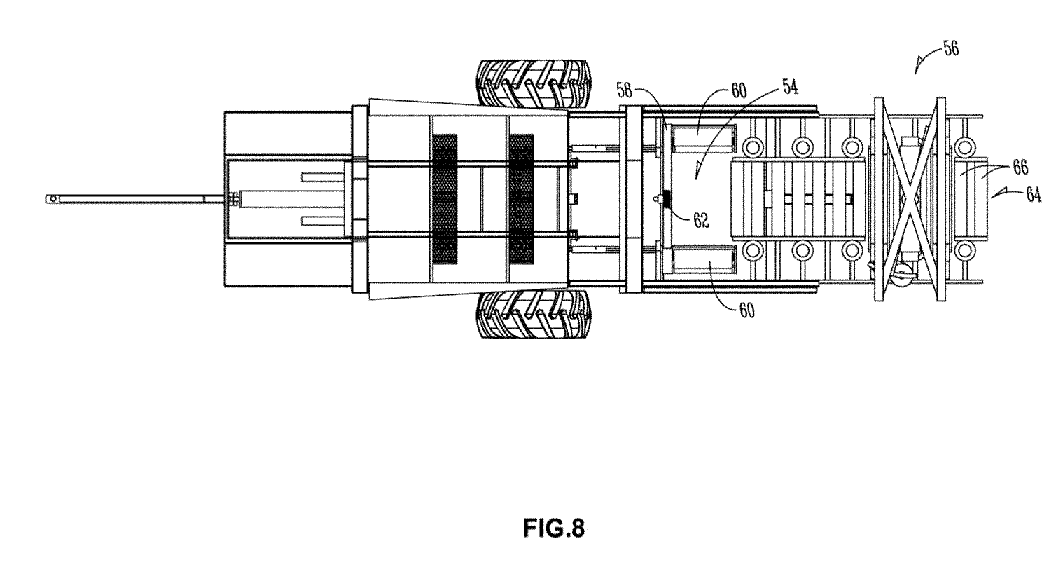

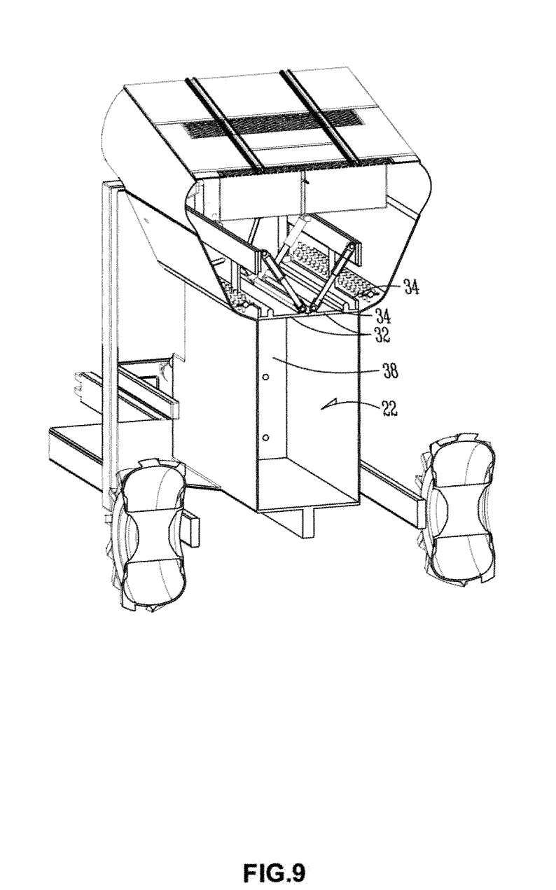

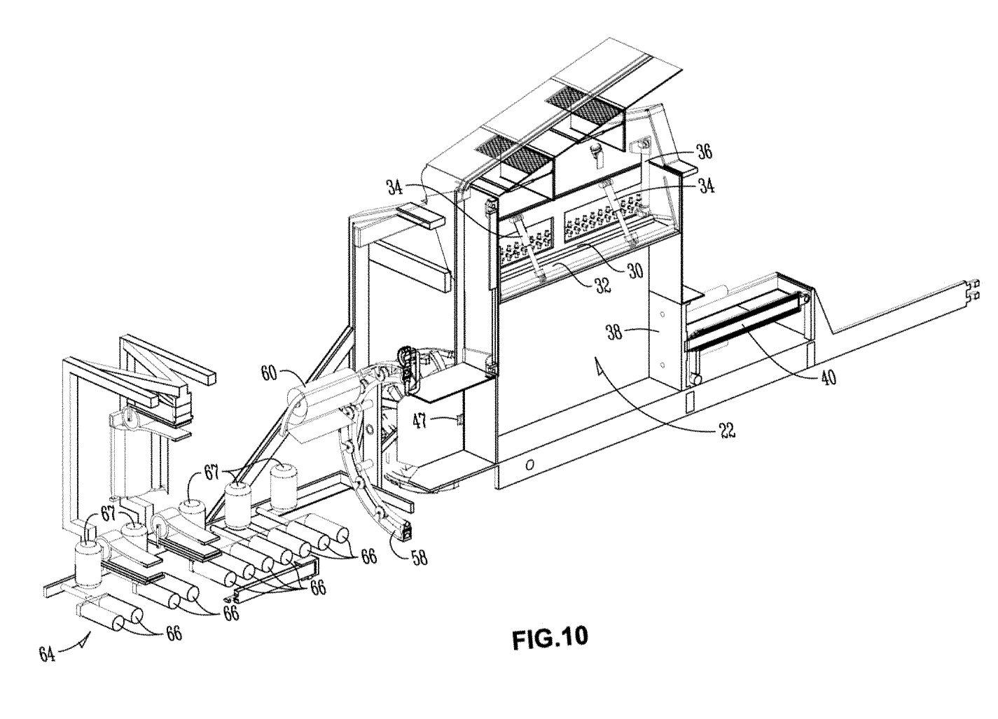

### DETAILED DESCRIPTION OF THE INVENTION

The bale forming and wrapping machine of the present invention is generally designated by the reference numeral 10. In a preferred, but not limited to, embodiment, the machine is built on or sits on a trailer 12 with wheels 14 and a tongue 16 adapted to be hitched to a tractor or other vehicle to pull the machine 10 through a field during harvesting of crop or residue material. The machine 10 generally includes a bale forming station 18 and the bale wrapping station 20.

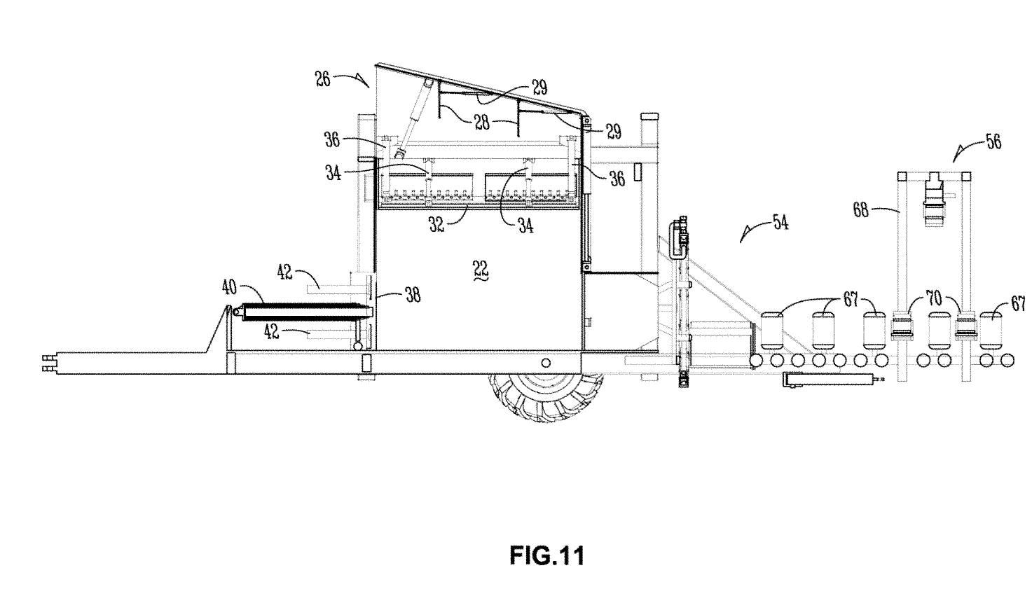

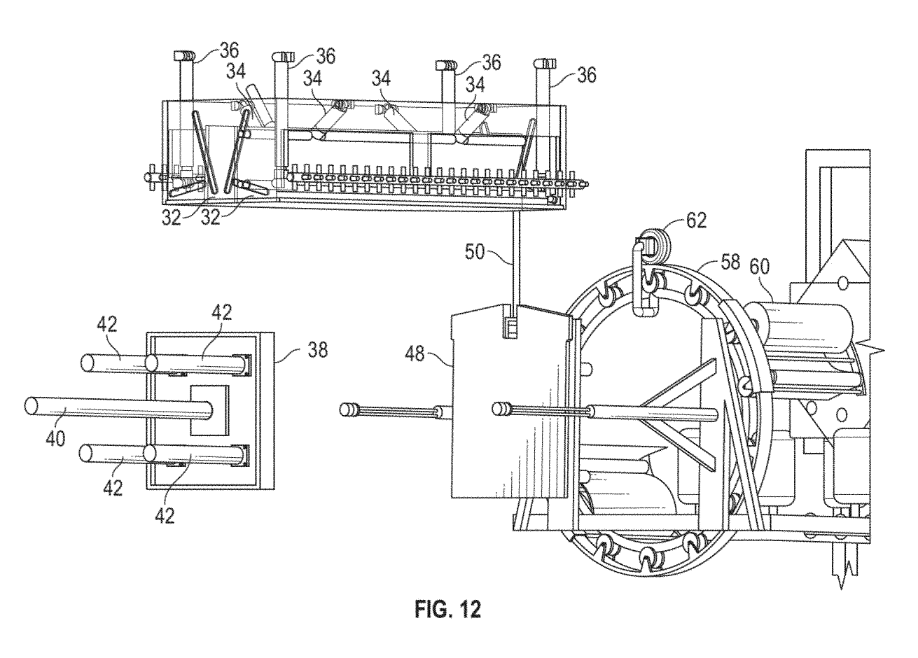

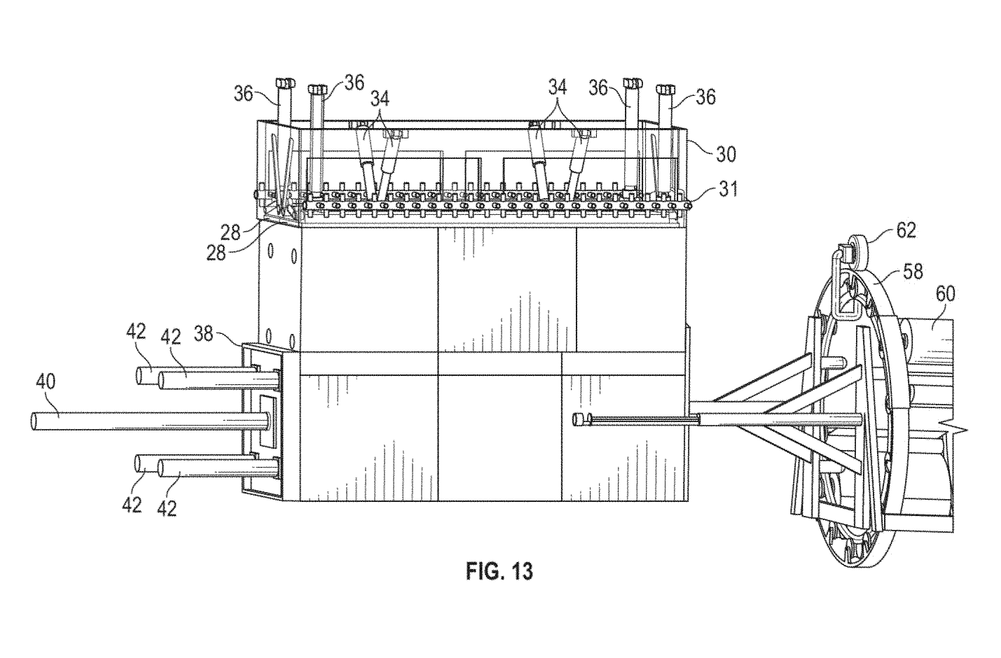

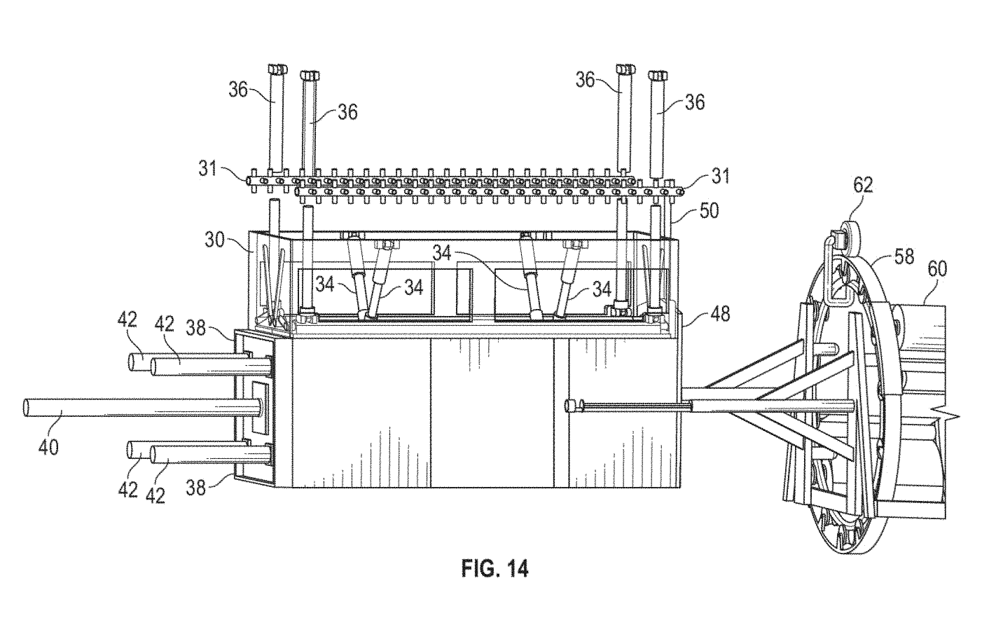

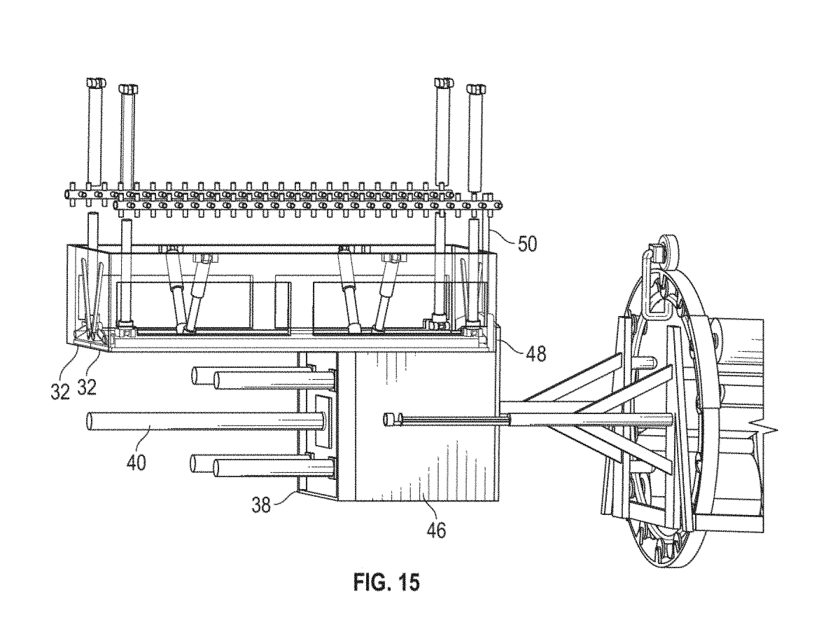

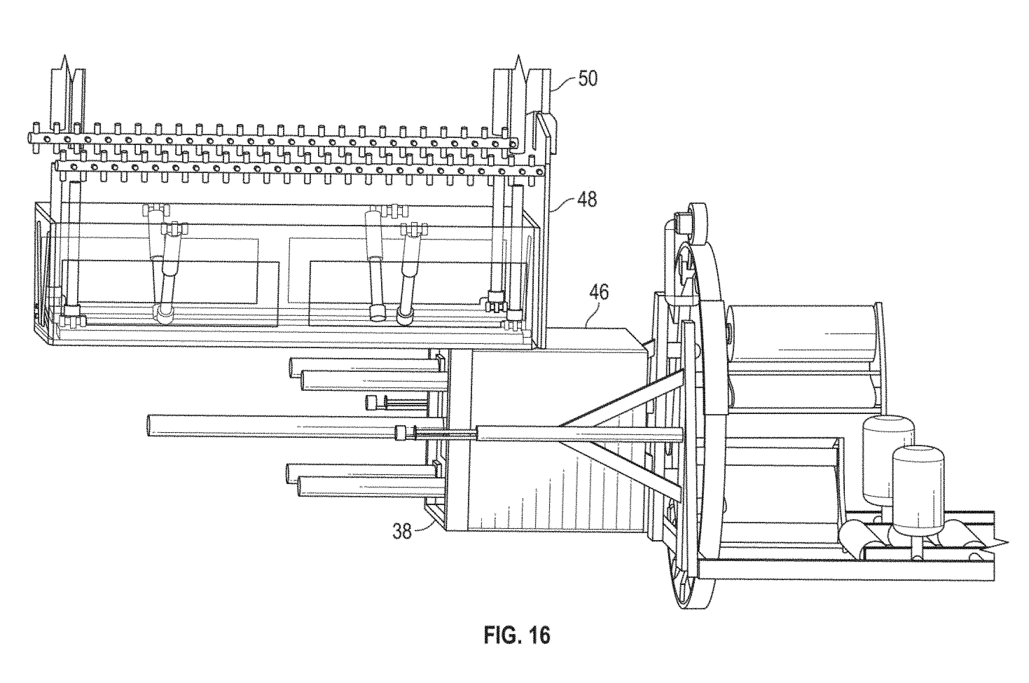

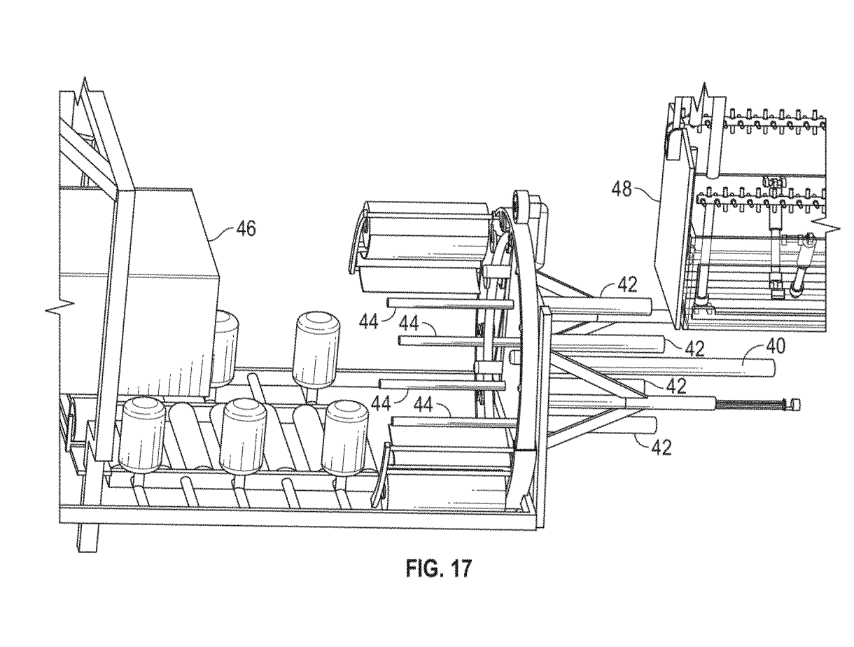

The bale forming station 18 includes a chamber 22 for receiving material, such as forage, that is to be baled. The chamber 22 includes a roof 24 with a front opening 26 through which the material is deposited into the chamber 22 from the discharge chute of a harvesting machine (not shown). Air vents 27 are provided in the roof to allow displaced air to exit or discharge from within the chamber 22, thus reducing internal pressure and minimizing loss of material. Deflectors 28, which are controlled by cylinder 29 (FIG. 11), are provided for even product distribution in the chamber 22. The height and/or slope of the roof 24 can be controlled by one or more hydraulic cylinders 25 for transportation purposes. The upper portion of the compression chamber 22 also includes agitators 31, preferably on each side of the chamber, which helps distribute material evenly within the chamber 22.

An upper frame 30 is provided in the top portion of the chamber 22, and supports a pair of compression plates 32. Preferably, the plates 32 are mounted on end tracks, rather than hinges. The plates 32 are adapted to be moved between a substantially vertical open position, and a horizontal closed position. A plurality of hydraulic cylinders 34 can be extended and retracted so as to close and open the plates 32. Another set of hydraulic cylinders 36 are located in the upper corners of the chamber 22 and can be extended so as to lower the frame 30 and the plates 32 and retracted to raise the frame 30 and the plates 32. When the plates 32 are lowered by the cylinders 36, material within the chamber 22 is compressed vertically to approximate ½ the height of the chamber 22. The plates 32 can be fitted with an anti-plugging process or device, such as but not limited to, air blast to loosen compacted material from between the plates, which allows material to be fed into the chamber 22 and a horizontal closed position.

The chamber 22 also includes a horizontal compression plate or ram 38 movable between retracted and extended positions by a ram cylinder 40. The ram plate 38 includes a plurality of horizontal hydraulic cylinders having forwardly extending cylinder shafts 42 and rearward extending rods 44 adapted to retract into the cylinders 42. The extended and retracted position of the rods 44 is controlled by a device, such as but not limited to, to hydraulics. The drawings show four tubes 42 and rods 44, though it was understood that a different number of tubes and rods can be utilized. When the ram cylinder 40 is extended to move the ram plate 38 rearwardly, material within the lower portion of the chamber 22 is compressed in a horizontal direction, thereby forming the square bale 46. After the bale 46 is formed, the ram plate 38 is retracted slightly, allowing for press door supports 47 to be released or retracted, and then a rear door 48 on the chamber 22 is raised by a hydraulic cylinder 50 to allow the ram to continue rearward to discharge of the bale 46 through the rear opening 52 in the chamber 22. As the bale 46 is extruded through the discharge opening 52, the bale is supported by a wrapping frame 64 and rollers 66 or a conveyor belt. The press door supports 47 prevents the bale 46 from catching and prevents buildup of material. Thus, the path of the bales is not obstructed

The bale 46 enters the wrapping station 20 as the bale is discharged from the compression chamber 22. The wrapping station 20 includes a first wrapping zone or stage 54 and a second wrapping zone or stage 56.

The first wrapping zone 54 includes a ring 58 which extends around the bale 46 and supports one or more wrapping rolls 60. The ring 58 rotates about a horizontal axis by a motorized drive wheel 62, thereby wrapping a plastic sealing material around the sides of the bale 46. A conventional pinch cutter (not shown) cuts the plastic wrap after the bale is wrapped, and holds the wrap for the next bale.

The bale 46 continues to move along a conveyor 64 to the second wrapping zone 56. The conveyor 64 is shown to be a plurality of powered rollers 66, but may take additional forms, such as a conveyor belt. Side idler rollers 67 are provided on each side of the conveyor to keep the bale on the conveyor.

The second wrapping zone 56 includes a frame 68 which supports a pair of motorized belts or tracks 70 which rotate the bale 46 about the longitudinal axis of the wrap station 20. The frame 68 can be raised by hydraulic cylinders (not shown) so as to lift the bale 46 slightly off the conveyor 64. A vertically oriented roll 72 of plastic wrapping material is mounted on a subframe 74, which in turn is mounted on the frame 68 for rotation around a vertical axis. A motor (not shown) rotates the subframe 74 around the bale as the bale is rotated between the belts 70, thereby wrapping the bale 46. Thus, the first and second wrap zones 54, 56 wrap the bale in transverse directions, thereby completely enclosing and sealing the bale in weather proof wrap. After the bale is wrapped in the second zone 56, the frame 68 is lowered and the conveyor 64 discharges the wrapped bale 46 from the rear of the machine 10.

As the bale moves from the first wrap zone 54 towards the second wrap zone 56, wrapping continues about the exposed rods 44 to provide a reduced diameter cone on the opposite end of the bale 46. Exposed rods 44 then retract to release the cone. The bale 46 then moves to the second wrapping zone 56. At this point, the rods 44 are then extended back into first wrap zone 54 and are wrapped by ring 58 to make or form the beginning cone for next bale. The beginning cone eliminates or minimizes spillage of bale material from the wrap bag. Knives or other cutting tools are provided at each of the wrap stages 54, 56 to cut the wrap material upon completion of the wrapping process. The wrapping frame or table 64 allows for coning of the wrap material on both ends of the bale. The wrap zones 54, 56 can operate simultaneously to wrap at the same time on different bales.

The lower ram cylinder 46 must be fully retracted before the upper compression plates 32 can be opened to allow material from the harvest chute to be fed into the chamber 22. One or more sensors can be used to sense the amount of material in the chamber, then actuate the cylinders 36 to close the plates 32. The cylinders 34 can then be actuated to push the plates 32 downwardly to compress the material in the chamber 22. Then, the ram cylinder 46 is actuated to push the ram plate 38 rearwardly thereby compress the material to the completed bale size. The ram cylinder 46 is then retracted slightly to remove the pressure on the exit door 48, and press door supports 47 to retract, which then can be raised by the cylinder 50. After wrapping is completed in zone one 54, the rods 44 can be retracted into the tubes 42 and the ram plate 38 retracted to the start position to prepare for formation of the next bale.

The plates 32 form a first press to compact the material downwardly in the chamber 22 and the ram 38 forms a second press to compact the material rearwardly in the chamber 22, thereby creating the compressed bale 46, which is then ejected from the chamber 22 for initial wrapping about a horizontal longitudinal axis in the first wrap zone 54 and final wrapping about a vertical axis in the second wrap zone 56, thereby fully enclosing and sealing the bale 46 in the plastic wrap material. These baling and wrapping operations can be performed as the trailer 12 is pulled continuously through the field, or while the trailer 12 is parked.

The machine 10 can be used to bale any type of material, including various crops, crop residue, wood chips, sawdust, mulch, and the like. The bales can be used for any desired purpose, depending upon the material being baled, including animal feed, fuel, ethanol production, landscaping materials, etc. The square bales can be stacked for transport and storage. The machine 10 eliminates the need for multiple pieces of different equipment, and minimizes labor requirements and labor hours during harvest and baling.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed:

1. A baling and wrapping machine for harvested material, comprising:
a compartment for receiving forage material;
a first press for compressing the material in a first direction within the compartment;
a second press for compressing the material in a second direction within the compartment;
the presses creating a bale of compacted material;
a wrapping station downstream from the compartment;
a first wrapper to wrap the bale in a first direction in the wrapping station; and
a second wrapper to wrap the bale in a second direction in the wrapping station.

2. The machine of claim 1 wherein the first and second presses compress the material while the machine moves through a field.

3. The machine of claim 1 wherein the first and second wrappers wrap the material in transverse directions.

4. The machine of claim 1 further comprising a wheeled frame for supporting the compartment, the presses, the wrapping station and the wrappers.

5. The machine of claim 1 wherein the first wrapper forms a cone of wrapping material to receive a forward end of the bale.

6. The method of claim 1 wherein the first press compacts the material downwardly in the compartment.

7. The method of claim 6 wherein the second press compacts the material rearwardly in the compartment.

8. The method of claim 7 wherein the second press ejects the bale from the compartment.

9. The method of claim 7 wherein the compartment includes a rear door movable between a closed position when the material is compressed and an open position for ejecting the bale.

10. The method of claim 1 wherein the first wrapper includes a rotatable ring through which the bale passes and a roll of wrapping material on the ring to wrap the bale about a longitudinal horizontal axis as the ring rotates.

11. The method of claim 1 wherein the second wrapper includes a roller assembly to rotate the bale about a longitudinal axis and a rotatable frame with a roll of wrapping material to wrap the bale about a vertical axis as the bale and frame rotate.

12. A method of baling harvested material, comprising:
depositing harvested material into a compartment;
then compressing the material in a first direction;
then compressing the material in a second direction to form a bale;
then moving the bale out of the compartment;
then wrapping the bale in a first direction with a first protective layer; and
then wrapping the bale in a second direction with a second protective layer.

13. The method of claim 12 wherein the first and second protective layers fully enclosed the compressed material.

14. The method of claim 12 wherein the compressing steps are in vertical and horizontal directions.

15. The method of claim 12 further comprising forming a conical shape of the protective layer to receive a forward end of the bale.

16. The method of claim 12 wherein the bale moves longitudinally during wrapping of the first protective layer.

17. The method of claim 16 wherein the bale is rotated about a longitudinal axis during wrapping with the second protective layer.

18. The method of claim 12 wherein the bale is rotated about a longitudinal axis during wrapping with the second protective layer.

19. The method of claim 12 wherein the first protective layer is applied while rotating about a longitudinal axis.

20. The method of claim 19 wherein the second protective layer is applied while rotating about a vertical axis.

21. The method of claim 12 wherein the second protective layer is applied while rotating about a vertical axis.

22. The method of claim 12 wherein the compressing and wrapping steps are performed by a machine as the machine moves through a field where the material is harvested.
